(19) United States
(12) Patent Application Publication
(10) Pub. No.: US 2016/0364783 A1
(43) Pub. Date: Dec. 15, 2016

(54) SYSTEMS AND METHODS FOR VEHICLE PURCHASE RECOMMENDATIONS

(71) Applicant: TrueCar, Inc., Santa Monica, CA (US)

(72) Inventors: Meghashyam Grama Ramanuja, Santa Monica, CA (US); Pan Wu, Los Angeles, CA (US); Lin O'Driscoll, Mammoth Lakes, CA (US); Michael D. Swinson, Santa Monica, CA (US); Ludovica Rizzo, Los Angeles, CA (US)

(21) Appl. No.: 15/248,213

(22) Filed: Aug. 26, 2016

Related U.S. Application Data
(63) Continuation-in-part of application No. 14/736,932, filed on Jun. 11, 2015.
(60) Provisional application No. 62/011,969, filed on Jun. 13, 2014.

(51) Int. Cl. G06Q 30/06; G06F 17/30

(52) U.S. Cl. CPC G06Q 30/0631; G06Q 30/0625; G06F 17/3053; G06F 17/30867

(57) ABSTRACT

A vehicle data system may receive, via a website, a user query about a vehicle or features of a vehicle that may not actually exist. The vehicle data system can transform vehicle features representing a user-configured vehicle, compare the user-configured vehicle with inventory vehicles, determine how similar the user-configured vehicle is to each inventory vehicle, how likely each inventory vehicle may be purchased given the user-configured vehicle and consumer behavior modeled based on actual historical transaction data collected via the website. The vehicle features may be weighted. Feature weights can be automatically determined and continuously fine-tuned utilizing machine learning. Each inventory vehicle is scored utilizing a similarity vector that compares it with the user-configured vehicle. Top-ranked inventory vehicle(s) can then be recommended to the user via the website in real time.

### CROSS REFERENCE TO RELATED APPLICATIONS

This application is a continuation-in-part of, and claims a benefit of priority from U.S. patent application Ser. No. 14/736,932, filed Jun. 11, 2015, entitled “SYSTEMS AND METHODS FOR VEHICLE PURCHASE RECOMMENDATIONS,” which is a conversion of, and claims a benefit of priority from U.S. Provisional Application No. 62/011,969, filed Jun. 13, 2014, entitled “SYSTEMS AND METHODS FOR VEHICLE PURCHASE RECOMMENDATIONS,” both of which are fully incorporated by reference herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates generally to the field of automated generation of purchase recommendations. More particularly, embodiments disclosed herein relate to systems, methods, and computer program products for providing a VIN based upfront pricing on vehicles similar to a user's selected criteria, useful in improving vehicle merchandising for dealers and reducing price confusion to users.

### BACKGROUND OF THE RELATED ART

Today's consumers may do their research online on big ticket items such as vehicles before they visit a retailer's brick and mortar store to make a purchase of a desired item. To facilitate consumers in making their purchase decisions, then, a website may present a collection of items, along with images, prices, and descriptions, etc. of the items and information on physical retail locations such as stores, dealerships, etc. where transactions can take place to purchase the items. A website visitor may browse the collection of items, select an item, visit a store, and make a purchase of the item. This process of making a sale is referred to as “closing.”

Historically, the rate of closing a sale this way—starting with a consumer visiting a website and viewing an item presented by the website and concluding with the consumer making a purchase of the item at a physical location listed on the website for that item—is low. Many factors may contribute to the low close rate. For example, the information on the website may not accurately reflect what is available at the physical location. When the consumer actually visits the physical location, the desired item that the consumer viewed on the website may not even be at the physical location. Although the physical location may have items that are similar to the item desired by the consumer, they may be priced differently. Such inconsistencies may discourage the consumer from making a purchase and consequently contribute to the low close rate experienced by the parties involved. Consequently, there is room for innovations and improvements.

### SUMMARY OF THE DISCLOSURE

Discrepancies between what items for sale a consumer sees on a website versus what items are actually available for purchase at a physical location can contribute to low close rates. One way to improve the close rate is to reduce the price confusion for the users. To do so, in some embodiments, a vehicle data system with hardware and software supporting a website may determine a price for a vehicle and present the price to a consumer via the website.

Embodiments disclosed herein leverage various user-selected preferences to rank every unique Vehicle Identification Number (VIN) within the displayed dealerships based on different weighting schemes. Next, a combination of these vehicles is chosen such that recommended vehicles are similar to what the user has specified or inquired and have some variety for the user to choose from. According to embodiments, these steps can take place as soon as the user submits their preferences, together referred to as a user inquiry or query, to the vehicle data system via the website in real time.

In some embodiments, a vehicle data system may receive, via a website, a user query about a vehicle or features of a vehicle that may not actually exist. The vehicle data system can transform vehicle features representing a user-configured vehicle, compare the user-configured vehicle with inventory vehicles, determine how similar the user-configured vehicle is to each inventory vehicle, how likely each inventory vehicle may be purchased given the user-configured vehicle and consumer behavior modeled based on actual historical transaction data collected via the website. The vehicle features may be weighted. Feature weights can be automatically determined and continuously fine-tuned utilizing machine learning. Each inventory vehicle is scored utilizing a similarity vector that compares it with the user-configured vehicle. Top-ranked inventory vehicle(s) can then be recommended to the user via the website in real time.

Some embodiments of a system may include at least one server machine embodying a vehicle data system. The at least one server machine may be communicatively connected to a client device over a network. The vehicle data system may include a processing module particularly configured to receive a user query about vehicle features via a website; based on the user query, transform a set of vehicle features representing a user-configured vehicle; generate a similarity vector for each inventory vehicle of a plurality of inventory vehicles, the similarity vector representing a measure of similarity between the user-configured vehicle and the each inventory vehicle in view of the set of vehicle features; generate a probability for each inventory vehicle of the plurality of inventory vehicles, the probability representing a likelihood that the inventory vehicle is to be purchased by the user, given the user-configured vehicle and the similarity vector associated with the each inventory vehicle; generate a score for each inventory vehicle of the plurality of inventory vehicles based on the similarity vector and the probability; rank each inventory vehicle of the plurality of inventory vehicles based on the score associated therewith; generate a recommendation containing at least one top-ranked inventory vehicle of the plurality of inventory vehicles; and responsive to the user query, present the recommendation to the user via a user interface of the website running on the client device.

Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings in which like reference numbers indicate like features.

FIG. 1 depicts a diagrammatic representation of one example of a system operating in a network environment according to some embodiments disclosed herein;

FIG. 2 depicts a flow chart illustrating one example of a method according to some embodiments disclosed herein;

FIGS. 3A-3D illustrate examples of applying a bias function to a similarity score;

FIGS. 4A-4P illustrate an example of operation of an embodiment;

FIG. 5 depicts a diagrammatic representation of one example of an AI-enabled recommendation engine for a vehicle data system supporting a website on the Internet according to some embodiments disclosed herein;

FIG. 6 depicts a flow chart illustrating one example of a machine learning methodology for the AI-enabled recommendation engine of FIG. 5;

FIG. 7 depicts a plot diagram illustrating one example of an asymmetric bias function for the AI-enabled recommendation engine of FIG. 5; and

FIG. 8 depicts a diagrammatic representation of a data processing system for implementing embodiments disclosed herein in a network environment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. For example, though embodiments of the invention have been presented using the example commodity of vehicles, it should be understood that other embodiments may be equally effectively applied to other commodities.

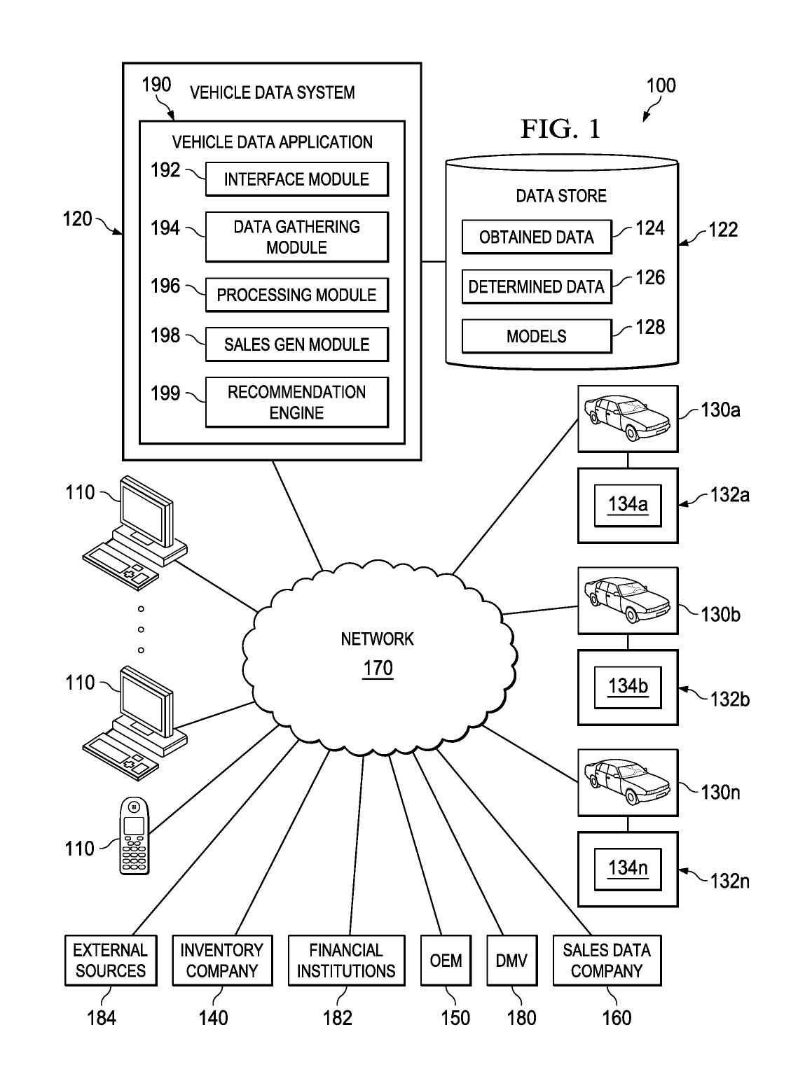

Embodiments of the systems and methods of the invention may be better explained with reference to FIG. 1 which depicts one embodiment of a topology which may be used to implement embodiments of the systems and methods of the invention. Additional examples can be found in U.S. patent application Ser. No. 12/556,076, filed Sep. 9, 2009, entitled “SYSTEM AND METHOD FOR AGGREGATION, ANALYSIS, PRESENTATION AND MONETIZATION OF PRICING DATA FOR VEHICLES AND OTHER COMMODITIES” and U.S. Pat. No. 7,945,483, entitled “SYSTEM AND METHOD FOR SALES GENERATION IN CONJUNCTION WITH A VEHICLE DATA SYSTEM,” which are fully incorporated by reference herein.

As illustrated in FIG. 1, topology 100 comprises a set of entities including vehicle data system 120 (also referred to herein as the TrueCar system) which is coupled through network 170 to computing devices 110 (e.g., computer systems, personal data assistants, kiosks, dedicated terminals, mobile telephones, smart phones, etc.), and one or more computing devices at inventory companies 140, original equipment manufacturers (OEM) 150, sales data companies 160, financial institutions 182, external information sources 184, departments of motor vehicles (DMV) 180 and one or more associated point of sale locations, in this embodiment, car dealers 130. Vehicle data system 120 may comprise various resources including hardware and software components supporting a website on network 170. An example website is TrueCar.com. Network 170 may include, for example, a wireless or wireline communication network such as the Internet or wide area network (WAN), publicly switched telephone network (PTSN) or any other type of electronic or non-electronic communication link such as mail, courier services or the like.

Vehicle data system 120 may comprise one or more computer systems with central processing units executing instructions embodied on one or more computer readable media where the instructions are configured to perform at least some of the functionality associated with embodiments of the invention. These applications may include a vehicle data application 190 comprising one or more applications (instructions embodied on a computer readable media) configured to implement an interface module 192, data gathering module 194, processing module 196 and sales generation module 198 utilized by vehicle data system 120. Furthermore, vehicle data system 120 may include data store 122 operable to store obtained data 124 such as dealer information, dealer inventory and dealer upfront pricing; data 126 determined during operation, such as a quality score for a dealer; models 128 which may comprise a set of dealer cost model or price ratio models; or any other type of data associated with embodiments of the invention or determined during the implementation of those embodiments.

More specifically, data stored in data store 122 may include a set of dealers with corresponding dealer information such as the name and location of a dealer, makes sold by the dealer, etc. Each of the set of dealers may be associated with a list of one or more vehicle configurations and associated upfront prices, where the upfront price associated with a vehicle configuration is associated with the lowest price that the dealer is willing to offer to a user for that vehicle configuration. Data in data store 122 may also include an inventory list associated with each of the set of dealers which comprises the vehicle configurations currently in stock at each of the dealers. A quality score may also be associated with each of the set of dealers in data store 122.

Vehicle data system 120 may provide a wide degree of functionality including utilizing one or more interfaces 192 configured to, for example, receive and respond to queries from users at computing devices 110; interface with inventory companies 140, manufacturers 150, sales data companies 160, financial institutions 182, DMVs 180 or dealers 130 to obtain data; or provide data obtained, or determined, by vehicle data system 120 to any of inventory companies 140, manufacturers 150, sales data companies 160, financial institutions 182, DMVs 180, external data sources 184 or dealers 130. It will be understood that the particular interface 192 utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, or almost any other type of interface which it is desired to utilize in a particular context.

In general, then, using these interfaces 192 vehicle data system 120 may obtain data from a variety of sources, including one or more of inventory companies 140, manufacturers 150, sales data companies 160, financial institutions 182, DMVs 180, external data sources 184 or dealers 130 and store such data in data store 122. This data may be then grouped, analyzed or otherwise processed by vehicle data system 120 to determine desired data 126 or models 128 which are also stored in data store 122. A user at computing device 110 may access Vehicle data system 120 through the provided interfaces 192 and specify certain parameters, such as a desired vehicle configuration. Vehicle data system 120 can select or generate data using the processing module 196 and may additionally generate upfront pricing information and vehicle recommendations using sales generation module 198 and recommendation engine 199. Interfaces can be generated from the selected data set, the data determined from the processing and the upfront pricing information using interface module 192 and these interfaces presented to the user at the user's computing device 110. More specifically, in one embodiment, interfaces 192 may visually present this data to the user in a highly intuitive and useful manner.

Turning to the various other entities in topology 100, dealer 130 may be a retail outlet for vehicles manufactured by one or more of OEMs 150. To track or otherwise manage sales, finance, parts, service, inventory and back office administration needs dealers 130a . . . 130n may employ a dealer management system (DMS) 132. Since many DMSs 132a . . . 132n are Active Server Pages (ASP) based, transaction data 134a . . . 134n may be obtained directly from a respective DMS 132 with a “key” (for example, an ID and Password with set permissions within a DMS 132a that enables transaction data 134a to be retrieved from the DMS 132a). Many dealers 130a . . . 130n may also have one or more websites which may be accessed over network 170, where pricing data pertinent to the dealer 130 may be presented on those websites, including any pre-determined, or upfront, pricing. This price is typically the “no haggle” (price with no negotiation) price and may be deemed a “fair” price by vehicle data system 120.

Additionally, a dealer's current inventory may be obtained from a DMS 132 and associated with that dealer's information in data store 122. A dealer 130 may also provide one or more upfront prices to operators of vehicle data system 120 (either over network 170, in some other electronic format or in some non-electronic format). Each of these upfront prices may be associated with a vehicle configuration such that a list of vehicle configurations and associated upfront prices may be associated with a dealer in data store 122. As noted above, this upfront price may, in one embodiment, comprise an offset from an inventory price for the vehicle configuration. It will be noted that an upfront price may be provided at almost any level of granularity desired. For example, a single upfront price may correspond to all vehicles of a particular make sold by the dealer, to all vehicles of a particular make and model sold by the dealer, to all vehicles of a particular make, model and trim sold by the dealer, etc.

Inventory companies 140 may be one or more inventory polling companies, inventory management companies or listing aggregators which may obtain and store inventory data from one or more of dealers 130 (for example, obtaining such data from DMS 132). Inventory polling companies are typically commissioned by the dealer to pull data from a DMS 132 and format the data for use on websites and by other systems. Inventory management companies manually upload inventory information (photos, description, specifications) on behalf of the dealer. Listing aggregators get their data by “scraping” or “spidering” websites that display inventory content and receiving direct feeds from listing websites (for example, Autotrader, FordVehicles.com).

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.) and sales transaction prices for tax purposes.

Financial institution 182 may be any entity such as a bank, savings and loan, credit union, etc. that provides any type of financial services to a participant involved in the purchase of a vehicle. For example, when a buyer purchases a vehicle they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 160 may include any entities that collect any type of vehicle sales data. For example, syndicated sales data companies aggregate new and used sales transaction data from the DMSs 132 of particular dealers 130. These companies may have formal agreements with dealers 130 that enable them to retrieve data from the dealer 130 in order to syndicate the collected data for the purposes of internal analysis or external purchase of the data by other data companies, dealers, and OEMs.

Manufacturers 150 are those entities which actually build the vehicles sold by dealers 130. In order to guide the pricing of their vehicles, manufacturers 150 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 184 may comprise any number of other various source, online or otherwise, which may provide other types of desired data, for example data regarding vehicles, pricing, demographics, economic conditions, markets, locale(s), consumers, etc.

It should be noted here that not all of the various entities depicted in topology 100 are necessary, or even desired, in embodiments of the invention, and that certain of the functionality described with respect to the entities depicted in topology 100 may be combined into a single entity or eliminated altogether. Additionally, in some embodiments other data sources not shown in topology 100 may be utilized. Topology 100 is therefore exemplary only and should in no way be taken as imposing any limitations on embodiments of the invention.

Before delving into the details of various embodiments of the invention, it may be helpful to give a general overview of an embodiment the invention with respect to the above described embodiment of a topology, again using the example commodity of vehicles. At certain intervals then, vehicle data system 120 may obtain by gathering data from one or more of inventory companies 140, manufacturers 150, sales data companies 160, financial institutions 182, DMVs 180, external data sources 184 or dealers 130. This data may include sales or other historical transaction data for a variety of vehicle configurations, inventory data, registration data, finance data, vehicle data, upfront prices from dealers, etc. This data may be processed to yield data sets corresponding to particular vehicle configurations.

At some point then, a user at a computing device may access vehicle data system 120 using one or more interface 192 such as a set of web pages provided by vehicle data system 120. Using this interface 192, a user (e.g., a website visitor) may specify a vehicle configuration by defining values for a certain set of vehicle attributes (make, model, trim, power train, options, etc.) or other relevant information such as a geographical location. Information associated with the specified vehicle configuration may then be presented to the user through interface 192. This information may include pricing data corresponding to the specified vehicle and recommendations of similar vehicles.

In some cases, vehicle data system 120 may construct a virtual vehicle based on query criteria specified by a website visitor and determine a price based on the virtual or query vehicle. However, this vehicle may not actually be available at a dealer lot, which may lead to false expectations on the build of the vehicle and the price generated by vehicle data system 120, and thus reducing customer satisfaction ratings for the website.

An exact trim match solution may help to eliminate or at least reduce this price confusion. However, this reduces what vehicle data system 120 may be able to recommend relative to a single trim. Also, the exact trim match does not take into consideration of the price, color, and other user preferences into building the recommendations. Moreover, a dealer has to create a manual VIN based offer which can be relatively cumbersome, costly, and time consuming.

Embodiments disclosed herein leverage various user-selected preferences to rank every unique Vehicle Identification Number (VIN) within the displayed dealerships based on different weighting schemes. Next, a combination of these vehicles is chosen such that recommended vehicles are similar to what the user has specified or inquired, and have some variety for the user to choose from. According to embodiments, these steps can take place in real time, as soon as the user submits their preferences (together referred to as a user query or inquiry) to the vehicle data system via the website. Dealers do not have to (although they could) create manual offers and then communicate them to the vehicle data system for presenting same to the consumers. This method also increases the coverage (number of recommendations) since the recommendations are not limited to a single trim.

As will be explained in greater detail below, initially, a query vehicle is determined by a user interacting with a website configurator to configure a virtual vehicle. This virtual vehicle provides the basis for the query vehicle. The query vehicle may be modified by a set of “user preferences” that are captured (e.g., by the vehicle data system) in a user profile, to expand or focus on target vehicle search parameters.

Rather than trying to find a specific trim that matches the virtual vehicle or the query vehicle, a recommendation engine 199 compares the query vehicle with all the actual, physical vehicles in a vehicle inventory. This approach utilizes a “vector space model,” which involves transforming vehicle attributes into numerical quantities (stored as an n-dimensional numeric vector), and which are in turn used to compute similarity between vehicles by comparing the distance or similarity of two such vectors.

All inventory vehicles (actual, physical vehicles) have their vehicle attributes transformed and stored as vectors, which then form the “search space” of interest. The query vehicle (constructed based on a virtual vehicle configured by a user and adjusted by user preferences associated with the user) is transformed into a numerical vector of the same construction, and is then used to find inventory vehicle vectors that are close or similar in some way.

In some embodiments, the closeness, or similarity, may be defined by one of two metrics: “cosine similarity” which measures the apparent angle of two vectors, from the origin of the vector space; and “Minkowski distance” which is a measure of the distance between two vectors in our vector space. Minkowski distance is subtracted from 1, in order to determine the similarity. Minkowski distance is known to those skilled in the art and thus is not further described herein.

After the similarity score between the query vehicle and all inventory vehicles are calculated, recommendation engine 199 may determine a set of inventory vehicles based on the similarity score. In some embodiments, recommendation engine 199 may categorize these recommended inventory vehicles as, for instance, a good match, a great match, etc.

According to embodiments, a query vehicle may be determined in many ways, some non-limiting examples of which are provided below:
from a user's behavior on the site; used to immediately present a list of vehicles that the user may be interested in
through a targeted search, such as a smart search or the current process of configuring a virtual vehicle
from vehicles similar to those that a user has expressed an interest in; such as for presenting new offers via email. For example, if a user's offer expires due to being sold, present them with similar vehicles in the area that are available.

In the above example, a recommendation process is triggered by a user configuring a virtual vehicle at a website implementing an embodiment of vehicle data system 120 having recommendation engine 199. In some embodiments, a recommendation process can be triggered by any of a plurality of events including, but are not limited to:
a. User submits leads
b. Dealer manually creates offer
c. Customer changes User Profile
d. Customer changes Vehicle Configuration on a certificate vehicle
e. Customer changes trim on a certificate vehicle (will trigger a new lead submission client-side)
f. Post—inventory processing (sold/better match)
g. Offer expiration date
h. User requests new offers
i. If any offer expires
j. Incentives added
k. Incentives deleted

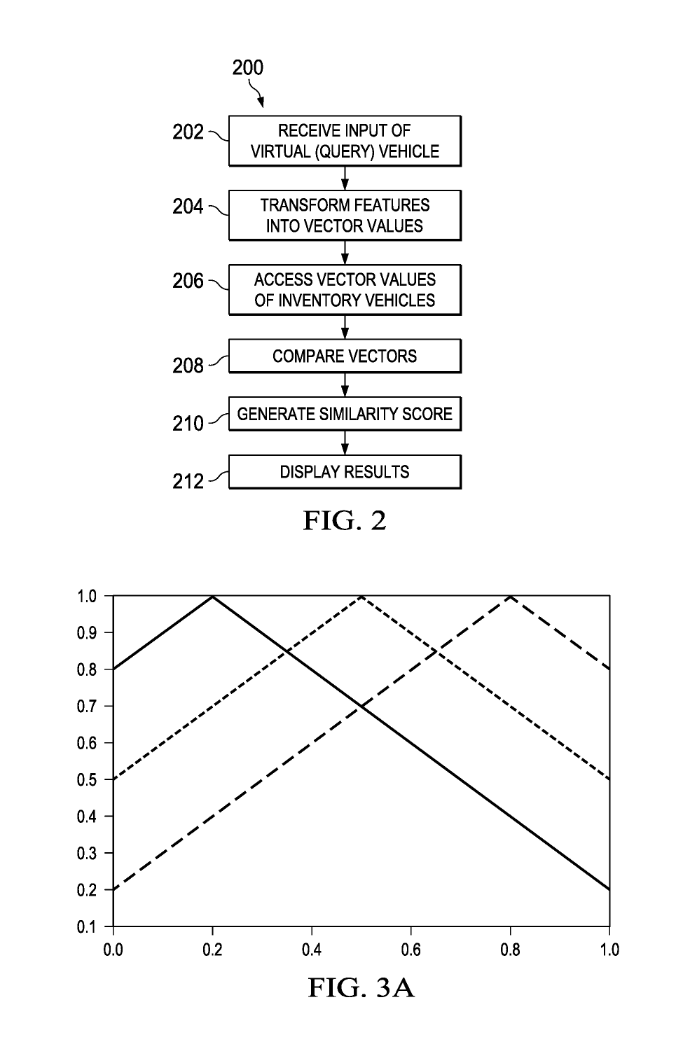

FIG. 2 is a flowchart 200 depicting operation of an embodiment. At a step 202, recommendation engine 199 may receive an input of a virtual or query vehicle. As noted above, this may comprise a user navigating a website to select one or more features of a vehicle make, model, trim, etc. Recommendation engine 199 may then, in a step 204 transform the features of the query vehicle into one or more numerical vector values. In a step 206, the recommendation engine may then access one or more databases of dealer inventory for corresponding vectors of in-stock vehicles. This may further include recommendation engine 199 generating corresponding feature vectors for identified vehicles. In other embodiments, the feature vectors may be generated beforehand. As will be explained in greater detail below, the feature values may be weighted according to one or more predetermined functions or criteria. In a step 208, the vectors for the query vehicle and the inventory vehicles are compared. A similarity score is then calculated in a step 210. In some embodiments, the scores may be normalized. Finally, a list of vehicles may be presented in a step 212.

A typical feature vector may be in any of a variety of formats. In one embodiment, a feature vector may include three columns and around 10-50 rows. An example feature vector, showing only five rows, is shown in Table 1 below:

TABLE 1

| VIN | FEATURE NAME | VALUE |
|---|---|---|
| ABCDEFG1234567 | price_msrp | 0.2 |
| ABCDEFG1234567 | color_green | 1 |
| ABCDEFG1234567 | trim_body_sedan | 1 |
| ABCDEFG1234567 | trim_mpg | 0.3 |
| ABCDEFG1234567 | option_gen_1001 | 1 |

As noted above, the feature vectors include representations of a vehicle's features transformed into a numerical format. In some embodiments, recommendation engine 199 is configured to handle continuous variables and discrete variables. Continuous variables are those which may have a sliding scale of values, such as price, trim miles per gallon, and the like. Continuous variables are represented by a scale transformation. Discrete values are exclusive, those which may be present or not, such as manual transmission, automatic transmission, four wheel drive, two wheel drive, etc. Binary variables are represented by a binary transformation.

An example of continuous variables is shown in Table 2 below:

TABLE 2

| | NORMALIZATION | NORMALIZATION | | |
|---|---|---|---|---|
| | PARAMETER: | PARAMETER: | EXAMPLE | EXAMPLE |
| FEATURE NAME | LOW END | HIGH END | (INPUT) | (OUTPUT) |
| price_msrp | 0 | 200,000 | 20,000 | 0.1 |
| trim_mpg | 0 | 200 | 20 | 0.1 |
| trim_year | 1950 | 2050 | 2014 | 0.64 |
| engine_size | 0 | 20 | 8 | 0.4 |
| engine_cylinders | 0 | 20 | 8 | 0.4 |

Shown in Table 2 are example low end and high end values (predetermined parameters), example inputs, and an example output. According to one embodiment, the low and high end values for a continuous variable are determined and the transformed variable is based on the difference between the query vehicle value and the low end value, divided by the difference between the low end value and the high end value.

The low end and high end for the continuous variables are chosen such that every vehicle can be represented in the system. As will be explained in greater detail below, each feature may further be provided a weight on each unit change of feature which can be adjusted using a bias function. Accordingly, in some embodiments, the transformation scheme standardizes vehicles in the system.

An example of a form for the transformation functions of the examples in Table 2 are written as below:

price_msrp=(config_msrp−msrp_low)/(msrp_high−msrp_low); if price_msrp >1.0, then price_msrp=1.0; if price_msrp<0.0, then price_msrp=0.0; if msrp is missing, then price_msrp is missing.

trim_mpg=(combined_mpg−mpg_low)/(mpg_high−mpg_low); if trim_mpg>1.0, then trim_mpg=1.0; if trim_mpg<0.0, then trim_mpg=0.0; if combined_mpg is missing, then trim_mpg is missing.

trim_year=(model_year−year_low)/(year_high−year_low); if trim_year>1.0, then trim_year=1.0; if trim_year<0.0, then trim_year=0.0; if model_year is missing, then trim_year is missing.

engine_size=(tc_engine_size−engine_size_low)/(engine_size_high−engine_size_low); if engine_size>1.0, then engine_size=1.0; if engine_size<0.0, then engine_size=0.0; if tc_engine_size is missing, then engine_size is missing.

engine_cylinders=(tc_engine_cylinders−engine_cylinders_low)/(engine_cylinders_high−engine_cylinders_low); if engine_cylinders>1.0, then engine_cylinders=1.0; if engine_cylinders<0.0, then engine_cylinders=0.0; if tc_engine_cylinders is missing, then engine_cylinders is missing.

In the example of Table 2, the MSRP has a low end of $0 and a high end of $200,000. An example query value is $20,000. According to the formula given above, then, the output is 0.1.

Example transformations of discrete variables are shown in Table 3 below:

TABLE 3

| FEATURE NAME | HAS FEATURE? | EXAMPLE (OUTPUT) |
|---|---|---|
| trim_transmission_auto | Yes | 1 |
| trim_transmission_manual | No | . |
| trim_drive_4wd | Yes | 1 |
| trim_drive_2wd | No | . |
| trim_make_honda | Yes | 1 |
| trim_make_toyota | No | . |
| color_red | Yes | 1 |
| color_green | No | . |
| option_gen_1001 | Yes | 1 |
| option_gen_1002 | No | . |

In the example illustrated, the discrete variables are identified as being present or not present. If the variables are present, they are assigned a value of 1. If not present, or missing, they are assigned a null value (which is represented by “.” in Table 3).

As noted above, once the vehicle parameters have been transformed into the corresponding vectors, a similarity score between the query vehicle and the inventory vehicles may be determined. Although any of a variety of methods may be used, an example is to use a Minkowski 1-norm to calculate a similarity score contribution from each feature, and then sum up the results as a total similarity score.

An example calculation process can be as follows:

1. Given two vehicles, one is “inquiry”, and another is “inventory”, both of them are represented as two transformed feature vectors.

2. For each feature, if either the “inquiry” or “inventory” is null, the feature's contribution to similarity score is 0.

3. For each feature, if both “inquiry” and “inventory” is not null, then the contributed similarity score is calculated as: weight-of-the-featurebias-function (“inquiry value”, “inventory value”)

4. Sum up all the contributed similarity score for all available features, and this is the similarity score between “inquiry” and “inventory” vehicles.

As can be appreciated, the contributions from each feature on the similarity score should be different. Some features can be more important than the other. For example, the difference between a Sedan and SUV (which refers to a body style) could be much larger than whether the vehicle has a floor mat (which is an option).

To incorporate the different contributions of each feature, some embodiments introduce a weight on each feature. The weight may initially be assigned from experience and/or domain expertise, and later be dynamically adjusted using user preference(s)/other data source(s).

For a discrete feature, its value is 0 or 1, and its contribution on the similarity is straightforward. However, for a continuous feature, its contribution is weakened due to the “fraction difference.” Accordingly, a weight may be assigned according to a “Unit Change of the Scaled Feature”, which can be implemented as a bias function.

Such a bias function aims to solve the problem of assigning weight on a variable, rather than assigning weight on unit change of variable. The most common bias function may have the following general form:

Similarity=1.0−|−A−B|*(w1+w2*sign(A−B)) - - - (univariate scale) (herein, the bias function has the form: |A−B|*(w1+w2*sign(A−B))) in which A is the input (or “inquiry vehicle”) feature value, B is the “inventory vehicle” feature value. w1 is treated as the steepness parameter, and the w2 is treated as the skewness parameter. This general function form is referred to as a “univariate scale” because the derivative does not change according to the “inquiry vehicle” feature value.

Another further incorporated bias function may have the general form as shown below: Similarity=1.0−|A−B|/|A|*(w1+w2*sign(A−B)) - - - (inquiry-based scale) where the curve derivative changes according to the inquiry value. This general function form is referred to as an “inquiry-based scale” and could be taken as a better bias function to accommodate customer's price sensitivity (customer who inquiry low price vehicle would be more price sensitive than customer who inquiry high price vehicle).

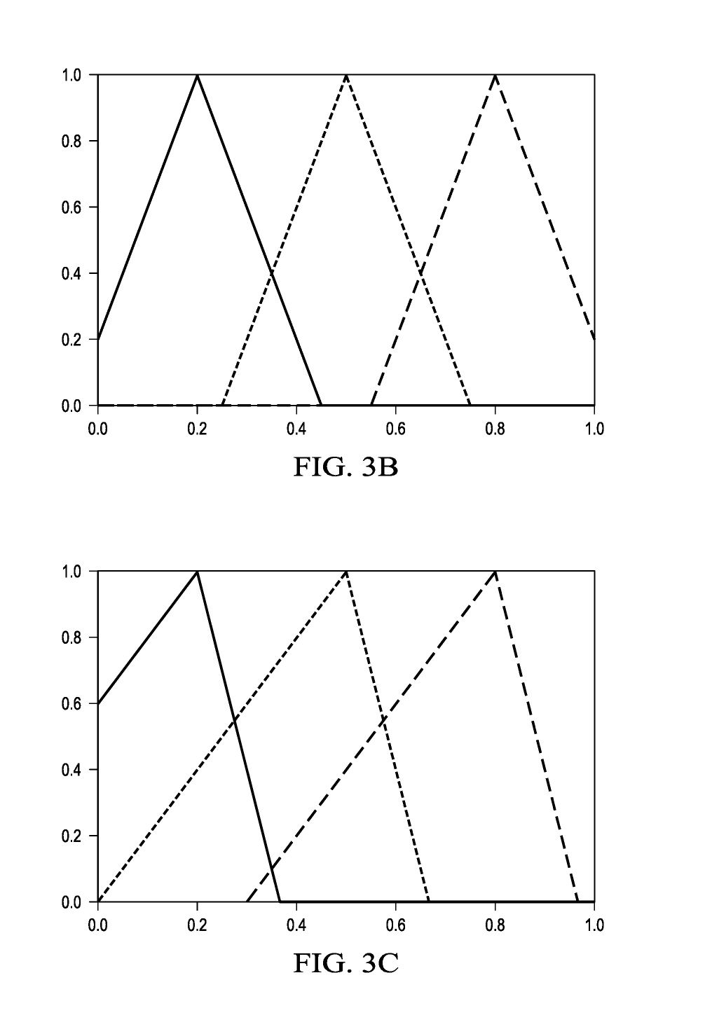

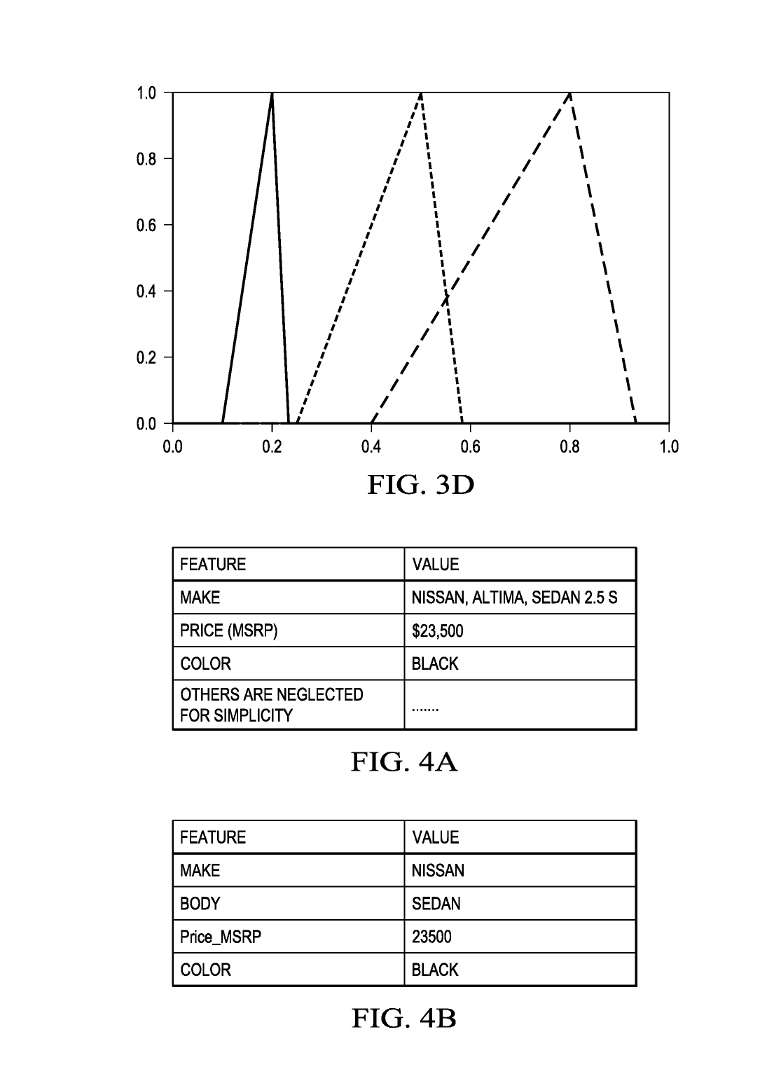

The function of these two general bias functions is shown by way of example using three feature values in FIGS. 3A-3D. Note the three “inquiry vehicle” feature values are: 0.2, 0.5, 0.8, while the “inventory vehicle” feature value is considered continuous between 0˜1.

FIGS. 3A-3C are of the “univariate scale” form, and FIG. 3D is of the “inquiry-based scale” form. FIG. 3A has parameter: w1=1, w2=0, which mimics the effect of absolute function; FIG. 3B has parameter w1=4, w2=0, which demonstrate the power of enhanced steepness; FIG. 3C has parameter w1=4, w2=−2, which shows how the skewness parameter could affect the curve shape; and FIG. 3D has parameter w1=4, w2=−2, and it shows how the inquiry-based scale function differs from the univariate scale one.

It may be observed that the similarity of this feature has a boundary: 1.0 as exact same, and 0.0 as totally different. However, in some cases, the low boundary may need to be removed. For example, if the customer want a $20,000 vehicle, then if low boundary exists, that means both $50,000 vehicle and $100,000 vehicle contribute 0 to the similarity; if there is no low boundary, the $50,000 vehicle contributes 0 to the similarity and the $100,000 vehicle contributes negative 0.5 to the similarity.

After the user inquiry is received by recommendation engine 199, the similarity score between this inquiry and all inventory (in this dealership) is calculated. This calculated similarity score is not guaranteed to be between 0 and 1. A results normalization may therefore be performed to force the revised similarity score from 0.0 to 1.0.

In particular, in some embodiments, after the inquiry vehicle is inputted into recommendation engine 199, and all inventory vehicles (in the dealership) have been calculated with a similarity score, recommendation engine 199 is operable to perform the following:

Identify the vehicle with the maximum and minimum similarity score: simi_score_max, simi_score_min

Assign each inventory vehicle a new similarity score: new_simi_score (vehicle_i)=(simi_score (vehicle_i)−simi_score_min)/(simi_score_max−simi_score_min)

Replace the old simi_score with the new_simi_score

In some embodiments, the original simi_score is stored as originally calculated without normalization. The relative score could be used as one way to suggest at least one recommendation, and a general rule-of-thumb could be applied (such as, if simi_score>0.8, call it “great match”; if semi_score between 0.6 and 0.8, call it “good match”, etc.).

In some embodiments, exclusive features such as color, make, transmission, etc. only contribute to the similarity score if the query and inventory vehicle is an exact match for that feature. For example, for the color feature, if a customer chooses “red” car, and if the inventory vehicle is “red”, then the inventory vehicle gets full weight; if the inventory vehicle is not “red”, the inventory vehicle gets zero weight.

However, other embodiments may assign weights fractionally to the discrete features. Thus, for example, if the customer chooses a “red” car, the “red” inventory vehicle gets full weight, a “white” inventory vehicle gets 50% of full weight, and a “yellow” inventory vehicle gets 20% of full weight, etc.

Continuing to use color as an example, such a fractional approach may employ a color transition matrix between different “reference colors” and “candidate colors”. Such a color transition matrix may be used to assign a weight to a candidate vehicle (e.g., an inventory vehicle that is at a dealer's lot or otherwise available for purchase). An example color transition matrix is shown in Table 4 below:

TABLE 4

| | White | Black | Red |
|---|---|---|---|
| White | 100% | 40% | 60% |
| Black | 30% | 100% | 70% |
| Red | 40% | 50% | 100% |

In this example, it is assumed that only three generic colors (white, black, and red) are available. However, any of a variety of methods may be used to construct a color transition matrix. For example, a red, green, and blue (RGB) color scale may be used to calculate the color similarity.

In some cases, it may be preferable to construct a color transition matrix based on (customer generated) lead and (customer purchased) sales data. That is, for all customers with a sale, the lead vehicle's color and sale vehicle's color are examined, and a color transition map may be constructed, an example of which is shown in Table 5 below.

TABLE 5
SALE COLOR GROUP/SALE COLOR

Lead

| Color | Lead | Default | Shades of Gray | | | Common | | Others | |
|---|---|---|---|---|---|---|---|---|---|
| Group | Color | Silver | Black | Gray | White | Blue | Red | Brown | Gold |
| Default | Silver | 21.8% | 17.7% | 19.4% | 17.4% | 9.8% | 8.9% | | |
| Shades | Black | 5.4% | 70.6% | 10.3% | 6.2% | | | | |
| of Gray | Gray | 12.7% | 16.7% | 44.5% | 11.4% | | | | |
| | White | 8.1% | 8.8% | 7.0% | 65.7% | | | | |
| Common | Blue | 7.8% | 9.6% | 10.0% | 8.2% | 52.1% | 8.6% | | |
| | Red | 7.0% | 10.4% | 8.1% | 6.6% | 6.2% | 58.4% | | |
| Others | Brown | | 8.0% | 12.5% | 10.2% | | 9.1% | 50.0% | |
| | Gold | | | | | | 33.3% | | 66.7% |
| | Green | 10.2% | 12.2% | | 8.2% | 10.2% | | | |
| | Orange | | 8.9% | 15.6% | 11.1% | | | | |
| | Purple | | 16.2% | 5.4% | 10.8% | | 5.4% | | |
| | Tan | 9.8% | 6.5% | 14.1% | 9.8% | | 8.7% | | |
| | Teal | | 16.7% | | | 16.7% | 16.7% | | |
| | Yellow | 6.3% | 12.5% | | 6.3% | 12.5% | 6.3% | | |

| Lead | | | | | | | |
|---|---|---|---|---|---|---|---|
| Color | Lead | Others | | | | | |
| Group | Color | Green | Orange | Purple | Tan | Teal | Yellow |
| Default | Silver | | | | | | |
| Shades | Black | | | | | | |
| of Gray | Gray | | | | | | |
| | White | | | | | | |
| Common | Blue | | | | | | |
| | Red | | | | | | |
| Others | Brown | | | | | | |
| | Gold | | | | | | |
| | Green | 42.9% | | | | | |
| | Orange | | 55.6% | | | | |
| | Purple | | | 56.8% | | | |
| | Tan | | | | 42.4% | | |
| | Teal | | | | | 50.0% | |
| | Yellow | 12.5% | | 6.3% | | | 37.5% |

As shown, the colors may be grouped according to closeness (e.g., Shades of Gray, Common, Others, etc.). Note that, in this example, matrix entries with no value suggest very small transition value. Color grouping can be done, for instance, based on past preferences, domain expertise, historical data, etc. As illustrated in Table 5, a buyer who prefers a color in one of the groupings is more likely to buy a vehicle in that grouping than from another color group. That is, a user who inquires about a silver vehicle is more likely to actually buy a vehicle in the “Shade of Gray” grouping than the “Common” grouping or the “Others” grouping. As an example, a buyer is 21.3% likely to buy a silver vehicle, 19.4% likely to buy a gray vehicle, and only 9.8% likely to buy a blue vehicle.

To assign weights based on this color transition matrix, one approach can be as follows. For a given lead submission color, i, the weight (φᵢⱼ) assigned to any color j can be thought of as a scaled factor of the highest value in that row of the transition matrix.

$${ϕ}_{ij} = \frac{{p}_{ij}}{max ( {p}_{ij} )} ∀ i , \\ where$$

$$i , j ∈ ( 1 , … , n )$$

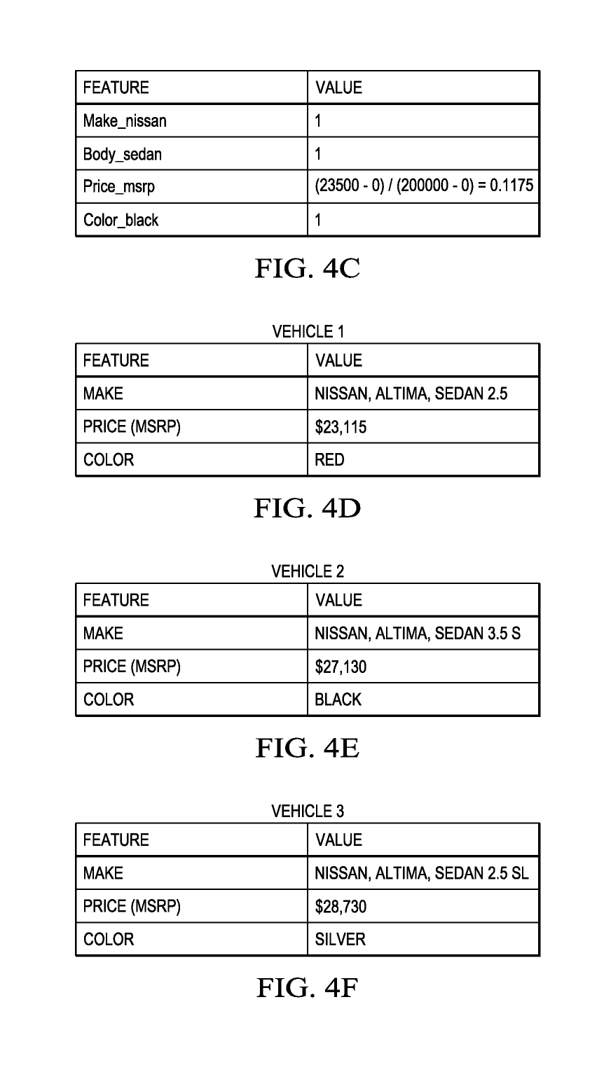

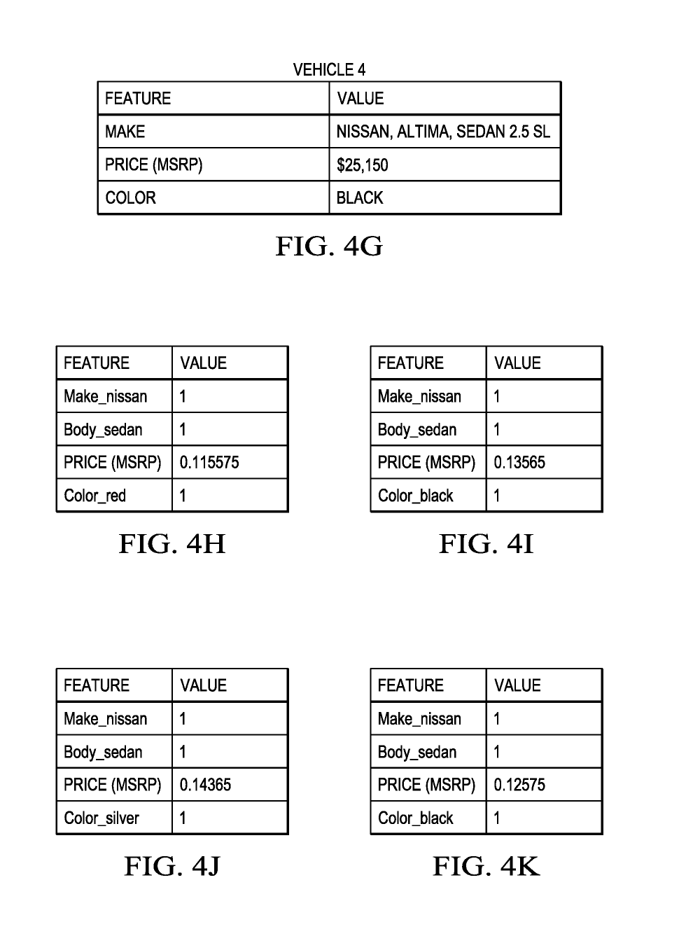

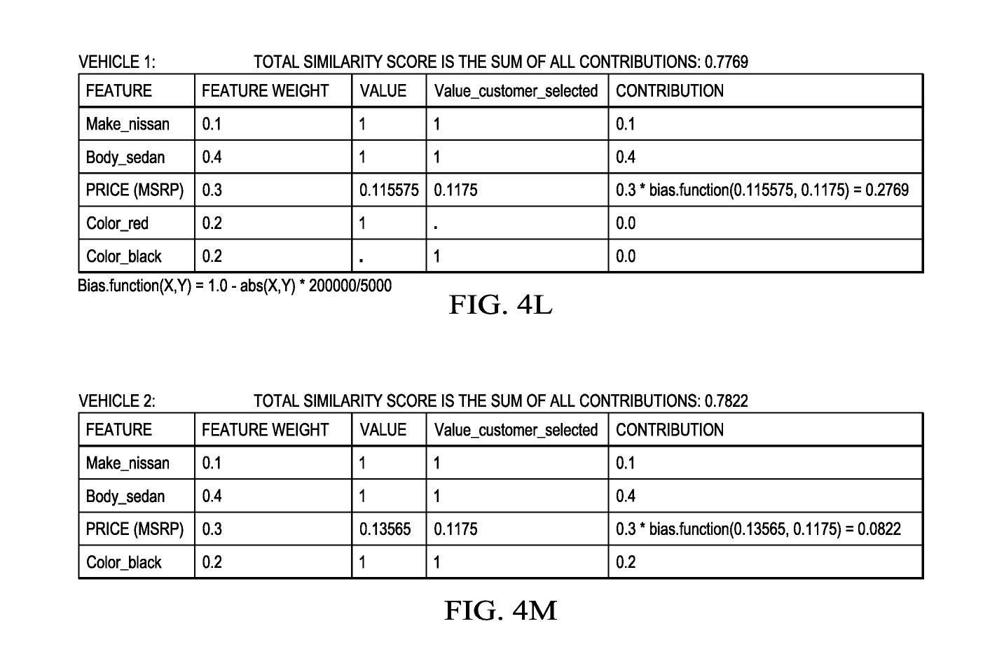

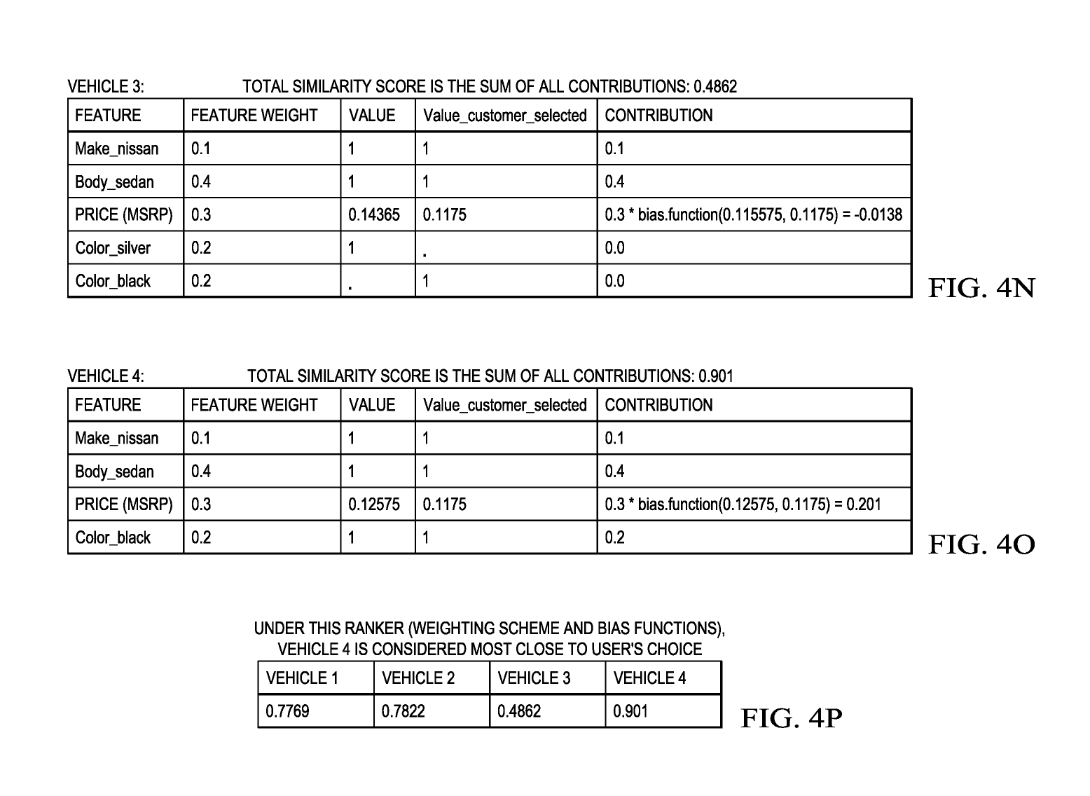

Operation of embodiments is shown by way of example in FIGS. 4A-4O. In the example illustrated, four features (make, body, price, and color) are considered.

As shown in FIG. 4A, a customer may select a vehicle. In the example illustrated, the vehicle is a black Nissan Altima sedan, with a MSRP of $23,500.

The vehicle's features are extracted (FIG. 4B) and transformed into numerical values (FIG. 4C). For example, the discrete variables of Make, Body, and Color, are assigned a value of 1. The continuous variable MSRP is calculated as discussed above, to be 0.1175.

For a particular dealer, four inventory vehicles and their corresponding features are identified (FIGS. 4D-4G). The features of these inventory vehicles are extracted and transformed into numerical values (FIGS. 4H-4K) in a manner similar to that discussed above.

The four vehicles are then compared with the query vehicle (FIGS. 4L-4O) by way of similarity comparison. In doing so, a feature weight may be applied to particular features and a bias function may be applied before or during the similarity comparison. For example, in FIG. 4L, a feature weight of 0.1 applies to the make; a feature weight of 0.4 applies to the body, a feature weight of 0.3 applies to price, and a feature weight of 0.2 applies to color. In addition, a bias function is applied to the price. The resulting similarity score is thus 0.1+0.4+0.2769+0+0. The similarity scores for vehicles 2-4 (FIG. 4M-FIG. 4O) can be handled similarly.

Finally, the resulting similarity scores for all the inventory vehicles may be displayed, as shown in FIG. 4P. In the example illustrated, after appropriate weighting and application of the bias function, Vehicle 4 has the highest similarity score.

Again, as discussed above, a feature's contribution to the similarity score can be calculated or otherwise computed for a content-based recommendation engine based on a weight of the feature and a bias function. For example, to incorporate the different contributions of each feature, a weight may initially be assigned to each feature by subject matter experts from experience and/or domain expertise (expert views), for instance, using a “Unit Change of the Scaled Feature” or a color transition matrix. The assigned feature weight may later be dynamically adjusted by the recommendation engine using user preference(s) and/or information from data source(s).

Since recommendations are made based on similarity scores of inventory vehicles relative to a user-configured vehicle (the query vehicle in the above example) and because feature weights can affect how an inventory vehicle's similarity score is ranked relative to the similarity scores of other inventory vehicles, it can be important to assign appropriate feature weights such that relevant recommendations that website visitors may actually follow can be generated.

However, collecting expert views can be a very time consuming, expensive, and tedious process. Even so, the collected expert views may not be consistent from one expert to another. Indeed, in some cases, expert views may not represent general website visitors' perception in a vehicle purchasing process. Furthermore, expert views may be hard to customize for each individual analytical model and to make further improvements. Accordingly, some embodiments may leverage artificial intelligence (AI), for instance, machine learning, to optimize and/or assign optimal feature weights as well as function forms for the content-based recommendation engine.

In the field of data analytics, machine learning refers to a methodology for devising complex models and algorithms that lend themselves to predictions. To enable a machine to “learn,” training data may be supplied as inputs to specially programmed analytical models running on the machine and the machine is taught how to produce desired outputs from the given input data. In this way, a machine can produce reliable, repeatable decisions and results and uncover hidden insights through learning from historical relationships and trends in the input data.

Wth machine learning, embodiments may provide a recommendation engine (hereinafter referred to as “AI-enabled recommendation engine”) that can perform significantly better than previous recommendation engines. For example, when a potential customer searches a website supported by a vehicle data system described above for a specific vehicle configuration, such a user-configured vehicle may not actually exist in a dealer's inventory. To better inform that potential customer and provide them with a better user experience and interaction with the website, it may be desirable to predict, as accurate as possible, what inventory vehicle the potential customer is most likely to buy, given the user-configured vehicle that the potential customer has specified on that visit to the website.

Leveraging machine learning, the vehicle recommendation engine disclosed herein can inform visitors of the website about the availability of inventory vehicles that are similar to a user-configured vehicle and that are actually available for purchase on the same day when a search for the user-configured vehicle was conducted via the website. The AI-enabled vehicle recommendation engine can simulate consumer purchasing behavior and, based on what it learned, make appropriate recommendations of inventory vehicles that website visitors are most likely to purchase.

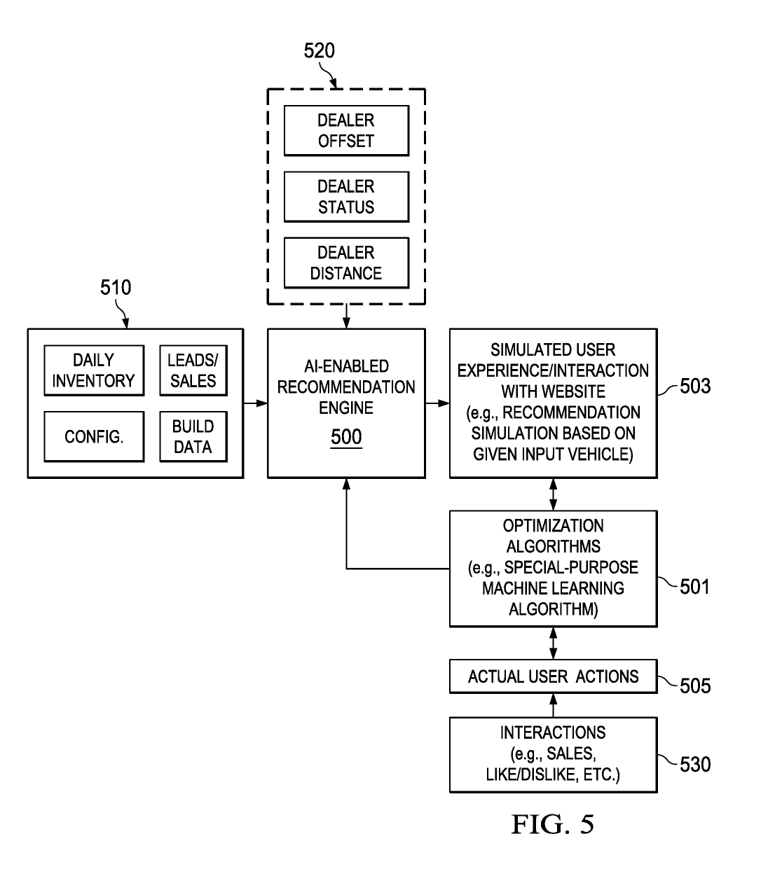

FIG. 5 depicts a diagrammatic representation of one example of an AI-enabled recommendation engine for a vehicle data system supporting a website on the Internet according to some embodiments disclosed herein. As exemplified in FIG. 5, AI-enabled recommendation engine 500 can consider many different types of data from disparate sources 510, 520, 530, to understand general website visitors' purchasing behaviors (e.g., how online customers make vehicle purchase decisions; specifically, how different vehicle features, such as price, color, engines, etc., influence those decisions) and then apply such knowledge to generate simulated user experience/interaction 503, utilizing optimization algorithms 501. Simulated user experience/interaction 503 may include a recommendation simulation for a given input vehicle (whether the input vehicle is a virtual or an actual vehicle). To improve the quality of the recommendations, actual user actions 505 may be obtained from collected historic customer experience and interactions data 530 and provided to a special-purpose machine learning algorithm.

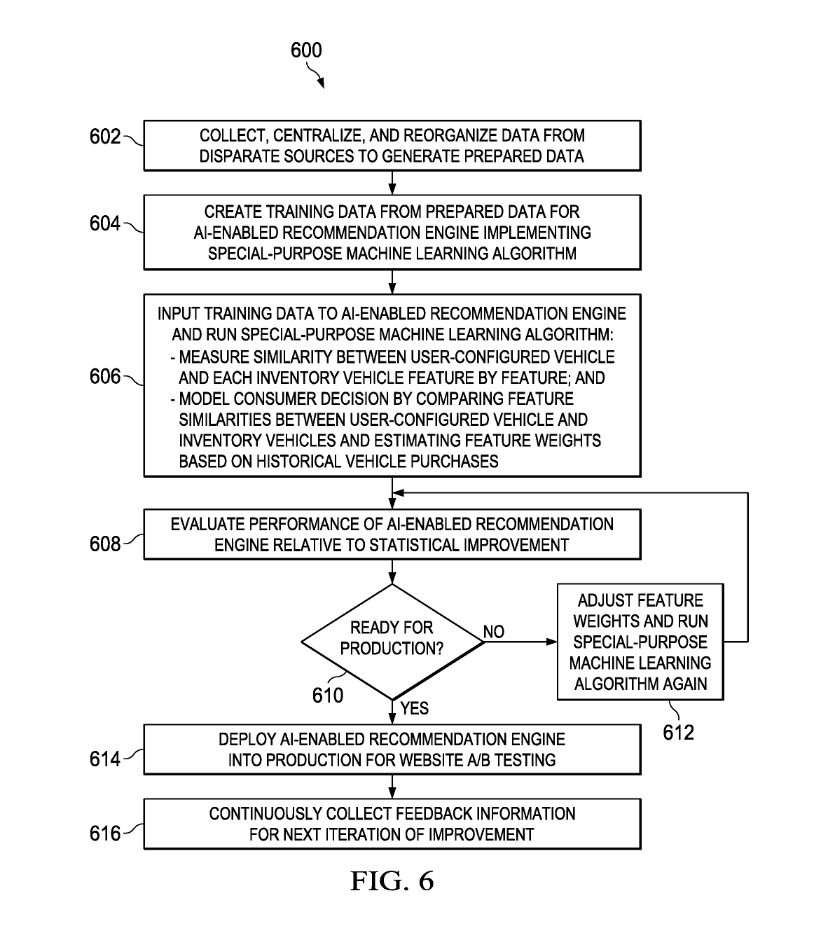

Referring to FIG. 6, machine learning methodology 600 may include collecting, centralizing, and reorganizing data from different data sources to generate prepared data that simulate a website visitor's experience (602). For example, data source 510 shown in FIG. 5 may be an embodiment of data store 122 shown in FIG. 1 and may store aggregated data such as “daily inventory” representing a dealer's vehicle availability on a daily basis, “leads/sales” representing a user-configured (or inquiry) vehicle and the final purchased vehicle, “configuration” representing the configuration data for different year-make-model, and “build data” representing the in-depth vehicle configuration data which provide all options for each specific VIN. Data source 520 shown in FIG. 5 may also be an embodiment of data store 122 or may represent DMS 132 shown in FIG. 1. Data source 520 may provide dealer-specific data such as “dealer offset” which represents how much price a dealer (e.g., dealer 130a representing an affiliate of vehicle data system 100) is willing to sell a vehicle based on the vehicle's invoice; “dealer status” which represents whether a dealer is active or inactive or suspending; and “dealer distance” which represents the distance between a dealer to all nearby zip codes. The data thus collected (e.g., by a server machine implementing the vehicle data system described above) may include website traffic data collected through a website supported by the vehicle data system. The website traffic data may include user interaction data such as online Live Offer interaction. Additionally, actual customer vehicle purchasing information may be collected (e.g., transaction data 134a . . . 134n from DMS132a . . . 132n, respectively, as described above with reference to FIG. 1). As illustrated in FIG. 5, data from these disparate information sources are prepared and fed to the machine learning algorithm to optimize AI-enabled recommendation engine 500.

As a non-limiting example, an open source cluster computing framework such as Apache Spark can be built to run AI-enabled recommendation engine 500 on Java-based programming framework such as Hadoop that supports the processing of large data sets in a distributed computing environment. Other computing framework may also be used, as those skilled in the art can appreciate. In this non-limiting example, raw data collected from disparate information sources is centralized in a Hadoop file system, and AI-enabled recommendation engine 500 is particularly configured to implement process 600, such that it could provide robust recommendation simulation on any virtual/real input vehicle. That is, AI-enabled recommendation engine 500 can take any customer ID(s), sales vehicle ID(s), or dealership and date information, obtain the daily dealership inventory for that specific sales on that date, calculate all the feature vectors for each inventory vehicle and the user-configured input vehicle, and generate recommendations accordingly.

Referring to FIG. 6, all the relevant information about a website visitor (e.g., the website visitor's online browsing data, vehicle preference, configured vehicle, purchased vehicle, Live Offer interaction, etc.) can be determined from the data collected from disparate data sources. Reorganized from the perspective of each website visitor, the reorganized website visitor information may be centrally stored in a training database as inputs to train AI-enabled recommendation engine 500 utilizing a special-purpose machine learning algorithm (604). As further explained below, the special-purpose machine learning algorithm is particularly configured for AI-enabled recommendation engine 500 and applied over the prepared input training data to optimize different feature weights and functions (606). A statistical improvement is also measured to evaluate performance of AI-enabled recommendation engine 500 (608). Based on the performance evaluation (e.g., the increase in the likelihood of a website visitor making a vehicle purchase based on a recommendation by AI-enabled recommendation engine 500 of a particular inventory vehicle exceeded a predetermined threshold), a determination can be made as to whether AI-enabled recommendation engine 500 is ready for deployment to the website production stage (610). If so, AI-enabled recommendation engine 500 is deployed for A/B testing (614). For instance, different versions of a landing page of the website for presenting a recommendation may be tested to see how small changes can have a meaningful impact on the result. Feedback is collected at this stage for the next iteration of improvement (616). Otherwise, process 600 loops to adjust feature weights and reapply the special-purpose machine learning algorithm to the training data (612).

The particular website supported by the vehicle data system described above may allow their users (e.g., website visitors) to configure the ideal vehicle they would like to purchase. For instance, through a user interface of the website, a website visitor can select a year, model, and trim of a vehicle, a color of the vehicle, a body style of the vehicle, a particular type of transmission, and various vehicle options (e.g., provided by manufacturers and/or dealers). However, when that website visitor actually walks into a dealer's lot, the ideal vehicle that this potential customer had configured on the website may not actually be available at that dealer's lot and this potential customer has to make a decision whether to give up or purchase a vehicle in the dealer's inventory. A goal of the special-purpose machine learning algorithm described herein is to understand how customers make this decision (e.g., does the color of the ideal configured vehicle matters more than the body style, or perhaps the transmission type is the deciding factor in whether a purchase is made, etc.).

To predict customers' choice under various circumstances, the special-purpose machine learning algorithm may employ a linear scoring model that is particularly built to measure the similarity between a user-configured vehicle and each vehicle available in inventory. The special-purpose machine learning algorithm may also employ a multinomial logistic regression model that is particularly built to model consumer behavior/capture customers' choices, given the similarities between the user-configured vehicle and the available inventory vehicles thus determined utilizing the linear scoring model. These models are further described below.

Measuring Feature Similarity Using Linear Scoring Model

As described above, a vehicle can have continuous features and discrete (also referred to as categorical) features. These different types of features can be used to measure the similarity between a user-configured vehicle and each inventory vehicle that is available on a certain day (e.g., the day when a recommendation process is triggered by an event described above).

Examples of model variables representing continuous vehicle features (which are referred to hereinafter as “continuous variables”) may include, but are not limited to:
Manufacturer Suggested Retail Price (MSRP);
Miles Per Gallon (MPG);
model year;
engine size; and
engine cylinders.

Examples of model variables representing categorical vehicle features (which are referred to hereinafter as “categorical variables”) may include, but are not limited to:
color;
transmission;
drive type; and
body style.

In some embodiments, each continuous variable is scaled or otherwise transformed as described above. Input data for each scaled variable (which, in the non-limiting embodiments disclosed herein, represents a continuous vehicle feature) is processed using asymmetric bias functions that are particularly built for the particular scaled variable to penalize the difference between a user-configured vehicle and each candidate vehicle that a website visitor may end up purchase (e.g., an inventory vehicle available in a dealer's lot on the day that the website visitor submits the user-configured vehicle to the underlying vehicle data system such as vehicle data system 100 described above via the website supported by the vehicle data system).

For example, let i refer to an inventory vehicle and c refer to a user-configured vehicle. The following bias functions may be particularly built for a scaled variable x representing a specific continuous vehicle feature:

simil_x_pos=−(xᵢ−x_{c}) if xᵢ>x_{c}, 0 otherwise

simil_x_neg=−(x_{c}−xᵢ) if x_{c}>xᵢ, 0 otherwise

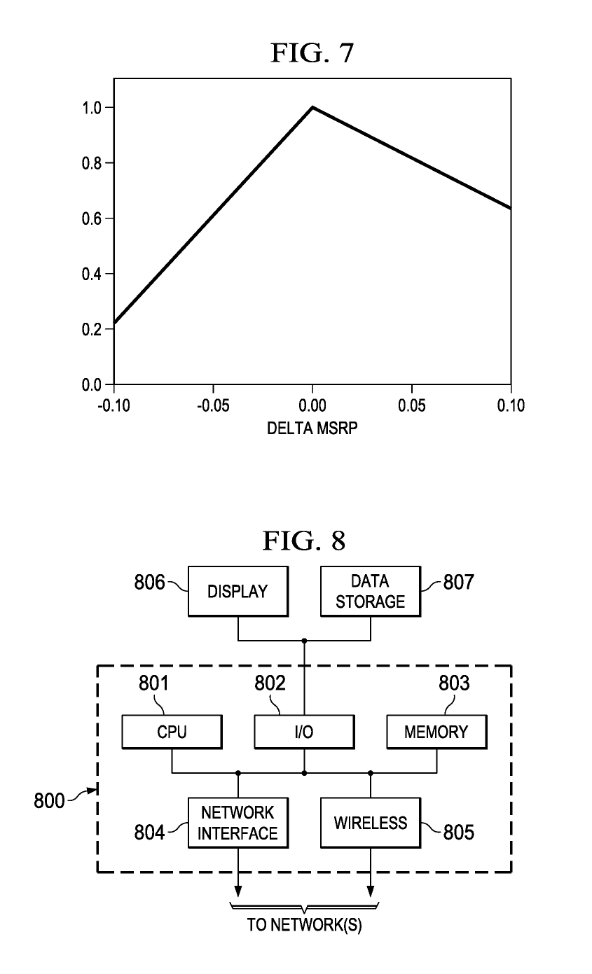

As a specific example, if candidate vehicles with the same mpg as the ideal configuration (of the user-configured vehicle) are not available, customers might prefer candidate vehicles with a higher mpg rather than a lower one. In this case, candidate vehicles with a lower mpg will be penalized more by the bias function. Similarly, if candidate vehicles with the same MSRP as the ideal configuration (of the user-configured vehicle) are not available, customers might prefer candidate vehicles with a lower MSRP rather than a higher one. In this case, vehicles with a higher MSPR will be penalized more by the bias function. This asymmetry is exemplified in FIG. 7.

In addition to continuous variables, the linear scoring model may incorporate categorical variables via transition matrices particularly built to capture user behavior. For example, as described above, a transition matrix of color can be built based on historical customers' behavior to capture the probability of a website visitor end up purchasing any color, given the color of the website visitor's configured vehicle. In this way, each pair of configured and inventory color is associated the probability of an inventory vehicle of a certain color is purchased, given the color of the user-configured vehicle.

Using the linear scoring model described above, a similarity vector X_{i,c} can be built to compare a user-configured vehicle with each inventory vehicle. For example, assume that vehicles are represented by two features: color (categorical) and mpg (continuous). Further assume that the user configured a red vehicle with 25 mpg and that the inventory vehicle to score is white with 20 mpg. Finally, assume that color is translated into a vector of similarity (X_{i,c}) using a transition matrix and a symmetric and unscaled bias function as described above. The similarity value for color is read from the transition matrix (transition from red to white, 0.4 in this example). The similarity value for mpg is computed using −abs(20-25) as the bias is symmetric and unscaled (where “abs” represents the absolute value), as illustrated in Table 6 below.

TABLE 6

| | User Configured | | |
|---|---|---|---|
| | Vehicle | Inventory Vehicle | X_{i,c} |
| Color | red | white | 0.4 |
| Mpg | 25 | 20 | −5 |

Modeling Consumer Behavior Using Multinomial Logistic Regression Model

In some embodiments, a multinomial logistic regression model can be used to capture how potential vehicle purchasers visiting a website may behave, given candidate vehicles available for purchase in lieu of a user-configured vehicle.

Consider a user-configured vehicle c (configured by a website visitor via a website supported by vehicle data system 100 described above, for instance) and an available inventory vehicle i where iε{1, . . . , I}. Suppose for each inventory vehicle i, a similarity vector X_{i,c} is built utilizing the linear scoring model described above.

Then, the probability for this website visitor to choose vehicle i given the similarity vector X_{i,c} can be defined as a multinomial logistic model:

$$P ( choose i \vert {X}_{. , c} ) = \frac{{e}^{ω \cdot {X}_{i , c}}}{{\sum }_{j = 1}^{I} {e}^{ω \cdot {X}_{j , c}}}$$

Skilled artisans appreciate that, in statistics, multinomial logistic regression can be used to generalize logistic regression to multiclass problems when a dependent variable of interest falls into any one of a set of categories which cannot be ordered in any meaningful way (e.g., colors of red, orange, yellow, green, black, white, gray, blue, etc.) and for which there are more than two categories and hence more than two possible discrete outcomes. In this case, the particular multinomial logistic model compares the characteristics of the different vehicles in inventory and tries to produce a higher score to the one that is the most likely to be purchased, given the user-configured vehicle.

The weights w are the parameters of the multinomial logistic model (i.e., coefficients of the similarity vector X_{i,c}). They can be estimated utilizing maximum likelihood estimation (MLE) based on historical transaction data. Skilled artisans appreciate that, in statistics, MLE refers to a method of estimating the parameters of a statistical model based on given data. More specifically, the multinomial logistic model defined above is trained based on historical transaction data of actual vehicle purchases made by website visitors from dealers affiliated with the vehicle data system described above. Training the multinomial logistic model may include comparing features of each user-configured vehicle and those of candidate vehicles that were available (e.g., on a dealer's lot) on the day of the purchase.

To continue the example presented above, consider only two features: color and mpg. As skilled artisans can appreciate, training the multinomial logistic model described above and utilizing an estimating method such as the MLE described above, the vehicle data system may operate to automatically produce, without relying on human experts, a vector of weights w, as exemplified in Table 7 below.

TABLE 7

| Feature | color | mpg |
|---|---|---|
| Weight | 0.9 | 0.1 |

With the particular statistical models described above, appropriate features and weights can be determined by the vehicle data system and used to generate a score for each inventory vehicle i, given a user-configured vehicle c, as follows:

score(i|c)=ω·X_{i,c}

Following the example presented above where the configured vehicle is red with mpg=25 and the inventory vehicle is white with mpg=20 and a similarity vector X_{i,c}=(0.4, −5), then

$$\begin{matrix}score ( ( white , 20 ) \vert ( red , 25 ) ) = ω \cdot {X}_{i , c} \\ = ( 0.9 , 0.1 ) \cdot ( 0.4 , - 5 ) \\ = 0.9 * 0.4 + 0.1 * ( - 5 ) \\ = - 0.14\end{matrix}$$

The score of the inventory vehicle in this example is −0.14.

This computation is performed for all inventory vehicles available for purchase. Each inventory vehicle is then ranked relative to other inventor vehicles available for purchase according to their similarity scores. A recommendation including one or more of the top-ranked inventory vehicles may then be generated.

The invention disclosed herein can provide many advantages, for instance, the models can be tuned with particular feature weights based on actual data (e.g., historical transactions) that represent the particular perspective of website visitors (e.g., based on historical transactions for the categorical feature “color,” the color white actually weighs more than the color black when silver is the desired but not available color). Utilizing machine learning, the models can be run in a continuous improvement cycle, adjusting to a new trend or a vehicle model launch. The feedback loop for the models can be easily automated, avoiding manually collecting information and providing consistent results.

FIG. 8 depicts a diagrammatic representation of a data processing system for implementing embodiments disclosed herein in a network environment. As shown in FIG. 8, data processing system 800 may include one or more central processing units (CPU) or processors 801 coupled to one or more user input/output (I/O) devices 802 and memory devices 803. Examples of I/O devices 802 may include, but are not limited to, keyboards, displays, monitors, touch screens, printers, electronic pointing devices such as mice, trackballs, styluses, touch pads, or the like. Examples of memory devices 803 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 800 can be coupled to display 806, information device 807 and various peripheral devices (not shown), such as printers, plotters, speakers, etc. through I/O devices 802. Data processing system 800 may also be coupled to external computers or other devices through network interface 804, wireless transceiver 805, or other means that is coupled to a network such as a local area network (LAN), wide area network (WAN), or the Internet. The enterprise servers, location servers, global location servers, tenant location servers, and various client devices described above may each be a data processing system that is the same as or similar to data processing system 800. Additionally, functional components necessary to implement embodiments of hybrid on-premises/off-premises data transfer disclosed herein may reside on one or more data processing systems that are the same as or similar to data processing system 800.

One embodiment of the invention comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein.

Numerous other embodiments are also possible. For example, recommendations generated by a recommendation engine implementing a recommendation process disclosed herein can be delivered in many ways. In addition to presenting such recommendations in real-time to the user based on a vehicle that the user has queried, delayed recommendations can be automatically made, for instance, via email or other communications channels. In some embodiments, automatic recommendations may first be generated and delivered in the form of real-time website recommendations and, subsequently throughout the upcoming days, weeks or months, may be updated and provided, for instance, via alert emails, notifications, messages, or the like, to include newly stocked vehicles in inventory that are also automatically matched. In some embodiments, such delayed recommendations can be automatically generated on a daily basis (or some other time intervals) using the same methodology disclosed herein for the real-time approach.

Embodiments disclosed herein can provide many advantages. For example, dealers do not have to create a manual offer and can easily explain the concept of a virtual vehicle price versus VIN based automated vehicle offer. For users, embodiments can reduce price confusion and users can get similar cars recommended to them with upfront prices. They do not have to go to the dealer to check for similar cars to the virtual vehicle. Embodiments can gather information on the similar type of vehicles on the lot and provide used car recommendations as alternatives to new car searches. Accordingly, embodiments can provide increased close rate, increased customer, and dealer satisfaction.

Embodiments discussed herein can be implemented in suitable computer-executable instructions that may reside on a computer readable medium (e.g., a HD), hardware circuitry or the like, or any combination. Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like. In embodiments of the invention, the computer has access to at least one database over the network.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the accompanying appendices, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and in the accompanying appendices, the meaning of “in” includes “in” and “on” unless the context clearly dictates otherwise.

It will also be appreciated that one or more of the elements depicted in the drawings/figures in the accompanying appendices can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. The scope of the present disclosure should be determined by the following claims and their legal equivalents.

What is claimed is:

1. A system, comprising:
at least one server machine embodying a vehicle data system, the at least one server machine communicatively connected to a client device over a network, the vehicle data system comprising a processing module configured to:
receive a user query about vehicle features via a website;
based on the user query, transform a set of vehicle features representing a user-configured vehicle;
generate a similarity vector for each inventory vehicle of a plurality of inventory vehicles, the similarity vector representing a measure of similarity between the user-configured vehicle and the each inventory vehicle in view of the set of vehicle features;
generate a probability for each inventory vehicle of the plurality of inventory vehicles, the probability representing a likelihood that the inventory vehicle is to be purchased by the user, given the user-configured vehicle and the similarity vector associated with the each inventory vehicle;
generate a score for each inventory vehicle of the plurality of inventory vehicles based on the similarity vector and the probability;
rank each inventory vehicle of the plurality of inventory vehicles based on the score associated therewith;
generate a recommendation containing at least one top-ranked inventory vehicle of the plurality of inventory vehicles; and
responsive to the user query, present the recommendation to the user via a user interface of the website running on the client device.

2. The system of claim 1, wherein each vehicle feature is associated with a feature weight and wherein the feature weight is automatically determined utilizing machine learning based on actual historical transactions collected by the vehicle data system.

3. The system of claim 1, wherein the similarity vector is generated utilizing a linear scoring model.

4. The system of claim 1, wherein the probability is generated utilizing a multinomial logistic regression model.

5. The system of claim 1, wherein the set of vehicle features comprises continuous features and categorical features.

6. The system of claim 5, wherein each continuous feature is represented in a linear scoring model as a scaled continuous variable.

7. The system of claim 6, wherein the scaled continuous variable is associated with asymmetric bias functions.

8. A computer program product comprising at least one non-transitory computer readable medium storing instructions translatable by a server machine embodying a vehicle data system to perform:
receiving a user query about vehicle features via a website;
based on the user query, transforming a set of vehicle features representing a user-configured vehicle;
generating a similarity vector for each inventory vehicle of a plurality of inventory vehicles, the similarity vector representing a measure of similarity between the user-configured vehicle and the each inventory vehicle in view of the set of vehicle features;
generating a probability for each inventory vehicle of the plurality of inventory vehicles, the probability representing a likelihood that the inventory vehicle is to be purchased by the user, given the user-configured vehicle and the similarity vector associated with the each inventory vehicle;
generating a score for each inventory vehicle of the plurality of inventory vehicles based on the similarity vector and the probability;
ranking each inventory vehicle of the plurality of inventory vehicles based on the score associated therewith;
generating a recommendation containing at least one top-ranked inventory vehicle of the plurality of inventory vehicles; and
responsive to the user query, presenting the recommendation to the user via a user interface of the website running on a client device.

9. The computer program product of claim 8, wherein each vehicle feature is associated with a feature weight and wherein the feature weight is automatically determined utilizing machine learning based on actual historical transactions collected by the vehicle data system.

10. The computer program product of claim 8, wherein the similarity vector is generated utilizing a linear scoring model.

11. The computer program product of claim 8, wherein the probability is generated utilizing a multinomial logistic regression model.

12. The computer program product of claim 8, wherein the set of vehicle features comprises continuous features and categorical features.

13. The computer program product of claim 12, wherein each continuous feature is represented in a linear scoring model as a scaled continuous variable and wherein the scaled continuous variable is associated with asymmetric bias functions.

14. A method, comprising:
receiving, a vehicle data system embodied on at least one server machine communicatively connected to a client device over a network, a user query about vehicle features via a website;
based on the user query, transforming, by the vehicle data system, a set of vehicle features representing a user-configured vehicle;
generating, by the vehicle data system, a similarity vector for each inventory vehicle of a plurality of inventory vehicles, the similarity vector representing a measure of similarity between the user-configured vehicle and the each inventory vehicle in view of the set of vehicle features;
generating, by the vehicle data system, a probability for each inventory vehicle of the plurality of inventory vehicles, the probability representing a likelihood that the inventory vehicle is to be purchased by the user, given the user-configured vehicle and the similarity vector associated with the each inventory vehicle;
generating, by the vehicle data system, a score for each inventory vehicle of the plurality of inventory vehicles based on the similarity vector and the probability;
ranking, by the vehicle data system, each inventory vehicle of the plurality of inventory vehicles based on the score associated therewith;
generating, by the vehicle data system, a recommendation containing at least one top-ranked inventory vehicle of the plurality of inventory vehicles; and
responsive to the user query, presenting, by the vehicle data system, the recommendation to the user via a user interface of the website running on the client device.

15. The method according to claim 14, wherein each vehicle feature is associated with a feature weight and wherein the feature weight is automatically determined utilizing machine learning based on actual historical transactions collected by the vehicle data system.

16. The method according to claim 14, wherein the similarity vector is generated utilizing a linear scoring model.

17. The method according to claim 14, wherein the probability is generated utilizing a multinomial logistic regression model.

18. The method according to claim 14, wherein the set of vehicle features comprises continuous features and categorical features.

19. The method according to claim 18, wherein each continuous feature is represented in a linear scoring model as a scaled continuous variable.

20. The method according to claim 19, wherein the scaled continuous variable is associated with asymmetric bias functions.
